(19) United States
(12) Patent Application Publication
(10) Pub. No.: US 2009/0290565 A1
(43) Pub. Date: Nov. 26, 2009

(54) COMMUNICATION SYSTEM, A ROUTER AND A COMMUNICATION CONTROL METHOD

(75) Inventor: Kenji Mangetsu, Kakegawa-shi (JP)

Correspondence Address: YOUNG & THOMPSON, 209 Madison Street, Suite 500, ALEXANDRIA, VA, 22314, US

(73) Assignee: NEC ACCESS TECHNICA, LTD., KAKEGAWA-SHI (JP)

(21) Appl. No.: 12/430,504

(22) Filed: Apr. 27, 2009

(30) Foreign Application Priority Data
May 23, 2008 (JP) 2008-135217

(51) Int. Cl. H04W 88/08

(52) U.S. Cl. 370/338

(57) ABSTRACT

A router has a function of handling a plurality of sessions and includes, a communication control unit for communicating with a plurality of terminals, and receiving a desired priority level of each session from each terminal at a time of starting communication; a priority adjustment unit for adjusting the desired priority level among terminals when it is determined that simultaneous communication of all sessions cannot be performed and the desired priority level competes among terminals if every desired priority level is permitted as it is without changing; and a priority control unit for assigning a transmission bandwidth to each session according to a determined priority level corresponding to each of the plurality of sessions.

This application is based upon and claims the benefit of priority from Japanese patent application No. 2008-135217, filed on May 23, 2008 the disclosure of which is incorporated herein in its entirety by reference.

### TECHNICAL FIELD

The present invention relates to a communication system including a router, and particularly to a router having a function of multi session handling to perform transmission bandwidth control for a plurality of sessions and its communication control method.

### BACKGROUND ART

In recent years, IP (Internet Protocol) communication is utilized in a wide variety of communication fields. The IP communication is not only utilized for just packet data communications but also utilized for real time data transfer. In particular, the IP communication has received wide attention for applying to a real time video delivery system and a voice communication network with the development in a network environment such as larger capacity of data transmission and higher transmission speed in the network. However, improvement of the communication quality for supporting such a network environment has become an important issue.

As one of methods to improve the communication quality in a network, there is a priority control method disclosed in Japanese Patent Application Laid-Open No. 2004-048156 or Japanese Patent Application Laid-Open No. 2007-274467, for example.

Japanese Patent Application Laid-Open No. 2004-048156 discloses technology in which an optimum priority control is performed by providing two stages priority buffer areas (a priority buffer area and a non-priority buffer area) for IP frames having a plurality of stages priority (multi-stage priority) According to the technology, an occurrence of congestion in the data transmission traffic is detected based on a usage rate of each of the priority buffer area and the non-priority buffer area. In order to reduce data volumes flowing into one of buffer areas in which the data transmission traffic congestion is being occurred, control is performed to change a boundary level value which is used to determine the priority classification corresponding to the buffer area. The boundary level value is set higher when the priority buffer area is congested, i.e., the data volume classified into “priority” will be decreased, and the boundary level value is set lower when the non-priority buffer area is congested, i.e., the data volume classified into “non-priority” will be decreased.

Japanese Patent Application Laid-Open No. 2007-274467 discloses technology in which the priority of received data is identified and the data transmission bandwidth is controlled according to the identified priority. According to the technology, a network repeater located on an edge of a communication network is provided with identification means to identify data of an emergency traffic with referring to the layer level 2 of communication protocol. The data identified as the emergency traffic is so controlled that a high priority is given to and transmitted preferentially.

In case of communication using a LAN (Local Area Network) system, for example, because the transmission bandwidth (or transmission bit rate) is controlled based on the best effort basis, it is difficult to maintain stable communication quality when a router provided with a function for handling multi session is used. In particular, because a router deals with a large amount of data volume at once, efficiency for handling such data volumes will become a problem when traffic load concentrates. For example, when a specific data stream monopolizes transmission bandwidth greatly in the limited bandwidth, transmission of other data streams may be stopped due to no bandwidth available. When a router having the function for handling multi session is used, it is highly required to introduce an optimum priority control function for assigning optimum transmission bandwidth necessary for each session and performing efficient and stable data communication.

### SUMMARY

An exemplary object of the present invention is to provide a router and a communication control method which can achieve efficient and stable data communication even if the router handles a plurality of sessions.

A router according to an exemplary aspect of the invention has a function of handling a plurality of sessions and includes, a communication control unit for communicating with a plurality of terminals, and receiving an advance notice from each terminal which indicates a desired priority level of each session of the terminal at a time of starting communication; a priority adjustment unit for adjusting the desired priority level among terminals when it is determined that simultaneous communication of all sessions cannot be performed and the desired priority level competes among terminals if every desired priority level is permitted as it is without changing; and a priority control unit for assigning a transmission bandwidth to each session according to a determined priority level corresponding to each of the plurality of sessions.

A router according to another exemplary aspect of the invention includes, a priority determination unit for distinguishing a priority value of an IP frame received at first from each terminal, and determining whether the IP frame is a priority control target or not by comparing the distinguished priority value with a predetermined reference priority value; a communication control unit for communicating with a plurality of terminals, and determining whether each IP frame, which follows the IP frame received at first, being corresponding to the priority control target or not in accordance with a notification from the priority determination unit; and a priority control unit for adjusting a volume of communication data corresponding to the IP frames determined as the priority control target so as to be preferentially transmitted.

### BRIEF DESCRIPTION OF THE DRAWINGS

Exemplary features and advantages of the present invention will become apparent from the following detailed description when taken with the accompanying drawings in which:

FIG. 1 is a block diagram showing an outline of system configuration of a communication system according to a first exemplary embodiment of the present invention;

FIG. 2 is a schematic block diagram showing a communication control example according to the first exemplary embodiment;

FIG. 3 is a sequence diagram showing an example of communication control according to the first exemplary embodiment;

FIG. 4 is a block diagram showing an outline of system configuration of a communication system according to a second exemplary embodiment of the present invention;

FIG. 5 is a sequence diagram showing an example of communication control according to the second exemplary embodiment;

FIG. 6 is a block diagram showing an outline of system configuration of a communication system according to a fourth exemplary embodiment of the present invention; and

FIG. 7 is a schematic block diagram showing a communication control example according to the fourth exemplary embodiment.

### EXEMPLARY EMBODIMENTS

Exemplary embodiments of the present invention will now be described in detail in accordance with the accompanying drawings.

Hereinafter, a wireless LAN system is exemplified and explained in detail as a communication system of exemplary embodiments of the present invention. However, the present invention can also apply to the wired LAN environment similarly as well as the wireless LAN system.

### 1. First Exemplary Embodiment

A first exemplary embodiment of the present invention discloses technology about an optimum priority control method in which a priority level of data transmission among terminals is dynamically controlled even if there exist a plurality of sessions to be handled in a predetermined transmission bandwidth. According to this technology, efficient and stable data communication on the whole can be realized. Details will be explained hereinafter.

### 1.1) Configuration

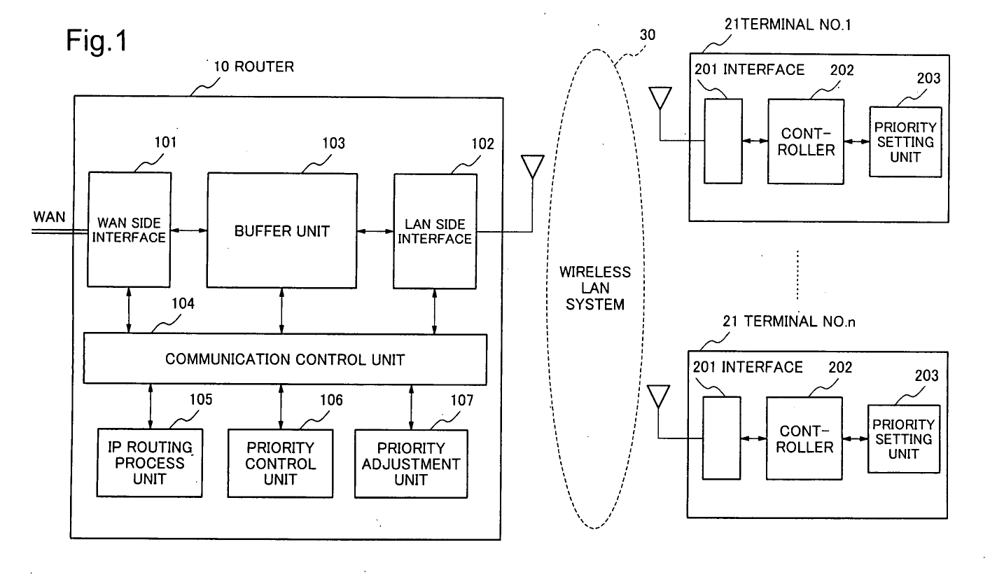

FIG. 1 is a block diagram showing an outline of system configuration of a communication system according to the first exemplary embodiment. This communication system includes a wireless LAN access point and a plurality of terminals. The wireless LAN access point has a function as a router. The wireless LAN access point is called “a router” in the following description.

This communication system is a wireless LAN system 30 including the router 10 and a plurality of terminals No. 1-No. n. That is, the router 10 is a base unit and each of terminals No. 1-No. n is a wireless unit. As mentioned later, the router 10 performs dynamic priority control for data transmission of the respective terminals when each terminal has requested a desired priority level for its own data transmission. That is, when the router 10 judges that simultaneous communication of a plurality of sessions cannot be performed if each desired priority level is maintained as it is, the router 10 performs dynamic and optimum priority control for instructing some of terminals to change the desired priority level. By this control, the router 10 can perform an efficient data transmission process for a plurality of terminals through a WAN (Wide-Area Network) circuit. In other words, the router 10 dynamically adjusts the desired priority level requested by each of the terminals as required. When the router 10 judges that transmission data volume (total transmission bit rate) exceeds the transmission bandwidth provided for the WAN circuit if every desired priority level requested by every terminal is permitted just as it is without changing, and when the router 10 judges that it needs to avoid competition of the desired priority level among those terminals, the router 10 instructs a certain terminal (or terminals) to change its desired priority level.

The router 10 includes a WAN side interface 101 for data transmission through the WAN circuit and a LAN side interface (an air interface) 102 for data transmission through the wireless LAN system 30, and between these interfaces 101 and 120, a buffer unit 103 for storing data of an up stream direction and a down stream direction is provided. Here, the up stream direction is a direction from a LAN side to a WAN side, and the down stream direction is a direction from the WAN side to the LAN side. Further, a communication control unit 104 which controls overall operation of the router 10 is provided in the router 10. The communication control unit 104 performs a communication control process according to this exemplary embodiment, and the communication control unit 104 performs the communication control process by controlling an IP routing process unit 105, a priority control unit 106 and a priority adjustment unit 107. The IP routing process unit 105 performs a routing process between the WAN side interface and the LAN side interface for IP packets stored in the buffer unit 103. The priority control unit 106 assigns a transmission bandwidth to each session according to a priority level corresponding to each of the plurality of sessions. The priority adjustment unit 107 adjusts the priority level of the session which has been notified by a terminal corresponding to the session. Incidentally, only functional constitution relating to the present invention is illustrated here, and other configurations necessary to work as a router are omitted.

As each of the terminals No. 1-No. n has basically the same configuration, the outline configuration of the terminal No. 1 will be described here. The terminal No. 1 has an interface (an air interface) 201 for connecting with the wireless LAN system 30, a controller 202 which controls overall operation of the terminal No. 1 and a priority setting unit 203 for setting a priority level of data transmitted from the terminal No. 1. The priority setting unit 203 has a function to change the priority level of the data transmitted from the terminal No. 1 under the control of the controller 202 in accordance with a priority change notice received from the router 10. Further, only functional constitution relating to the present invention is illustrated, and other configurations necessary to work as a terminal are omitted here.

Further, the wireless LAN system 30, which includes the router 10 and the terminals No. 1-No. n, is a wireless LAN system based on the standard of IEEE (The Institute of Electrical and Electronics Engineers, Inc.) 802.11a or IEEE 802.11g, for example.

### 1.2) Operation

Next, operation of the router and the terminals according to this exemplary embodiment will be described. In order to describe simply here, it is supposed that two terminals No. 1 and No. 2 are included in the wireless LAN system 30 for data transmission. And it is supposed that each of terminals has priority values “a” and “b”, and can set the priority value as the priority level of data transmission in a session. For example, when the priority values “a” and “b” have been set to “a=7” and “b=3” in advance within the priority range from 0 to 7, and each terminal uses two sessions, two sessions of each terminal are set to the priority level “a=7” and the priority level “b=3” respectively.

It is also supposed that the wired WAN circuit has 100 Mbps (Mega bit per second) of transmission bandwidth, and the wireless LAN has 54 Mbps of all transmission bandwidth. A total transmission bandwidth which can be allocated to each session of two terminals will be 54 Mbps below. A usual priority control process performs to assign more transmission bandwidth to each session having high priority first, and the remaining transmission bandwidth may be assigned to share among sessions having low priority. However, according to this exemplary embodiment, when the desired priority level requested by each terminal competes between terminals and simultaneous communication of all sessions by using the desired priority level cannot be performed, a priority change request is transmitted to one of terminals from the router 10 as the priority change notice. Hereinafter, it is explained in detail.

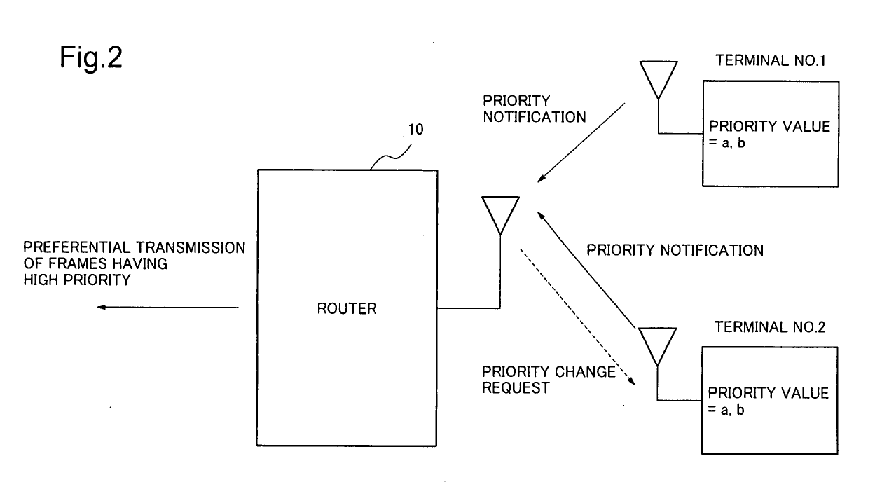

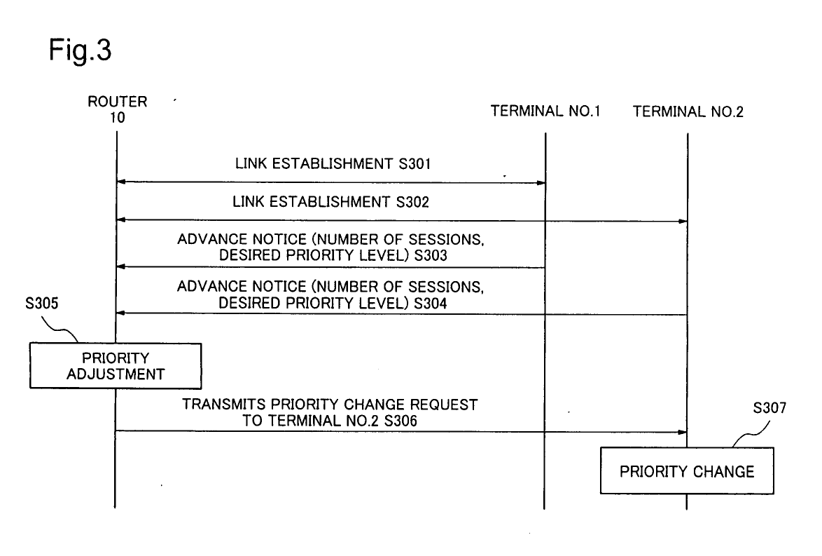

FIG. 2 is a schematic block diagram showing a communication control example according to the first exemplary embodiment. FIG. 3 is a sequence diagram showing an example of the communication control according to this exemplary embodiment. As shown in FIG. 2, each of the terminals No. 1 and No. 2 notifies in tandem the desired priority level (here, the same priority level is used in both terminals, for example,) for its own data transmission to the router 10. In this case, the router 10 transmits the priority change request to one of terminals because the desired priority level requested by respective terminals compete each other. For example, the priority change request is transmitted to a terminal which has accessed later. The terminal which has received the priority change request decreases the priority values of desired priority level “a=7 and b=3” for its two sessions respectively as necessary. For example, the desired priority levels are changed to “a=3 and b=1”, and it may notify the changed desired priority levels to the router 10 as a response. In doing so, competition of the priority level for each session between different terminals and an excess of transmission data flow in a usage transmission bandwidth can be avoided. Hereinafter, it will be described more specifically with referring to FIG. 3.

In FIG. 3, first, a link between the communication control unit 104 of the router 10 and the controller 202 of each terminal is established under a predetermined protocol. Here, the link between the router 10 and the terminal No. 1 is established (Step S301), and the link between the router 10 and the terminal No. 2 is established likewise (Step S302).

After link establishment, it is possible to communicate between the router 10 and each of the terminals No. 1 and No. 2 by HTTP (Hypertext Transport Protocol) protocol, for example. Each of the terminals No. 1 and No. 2 transmits management information including the number of sessions for performing simultaneous communication and desired communication quality (the desired priority level) of each session to the router 10 as an advance notice by using the HTTP protocol (Steps S303 and S304). Here, it is desirable to use tag information for transmitting information on the number of sessions and the desired priority level. Accordingly, any protocol other than the HTTP protocol may also be used, as long as it is possible to add and transmit information as a tag. However, it is desirable to use a protocol higher than the layer 4 protocol because it is interposed by an application control.

As an example, in each of the terminals No. 1 and No. 2, it is supposed that the number of sessions by TCP (Transmission Control Protocol) is 2 and the priority values of desired priority level for these two sessions are “a=7” and “b=3” respectively. Also, it is supposed that the communication control unit 106 of the router 10 has received the advance notice of the management information including the number of sessions and the desired priority level from the terminal No. 1 first (Step S303), and after that the communication control unit 106 has received the advance notice of the management information including the desired priority level having the same values from the terminal No. 2 (Step S304). The communication control unit 106 outputs the management information having received as the advance notice of each terminal to the priority adjustment unit 107, and a priority adjustment process is performed by the priority adjustment unit 107 (Step S305).

When the desired priority level of the terminal No. 1 and the terminal No. 2 competes each other, the priority adjustment unit 107 accepts the advance notice which has arrived first as a principle. And the priority adjustment unit 107 transmits the priority change request to the terminal which is a sender of the advance notice which has arrived later (Step S306). In this example, it is determined that the desired prior level “a=7” and “b=3” from the terminal No. 1 is effective, and the priority change request is transmitted to the terminal No. 2 which is a sender of the advance notice arrived later. The priority change request which instructs to lower the priority values of the desired priority level is transmitted by including in an added tag, for example.

When the priority change request is received, the controller 202 of the terminal No. 2 changes the priority values of the desired priority level “a=7” and “b=3” for two sessions to, for example, “a=3” and “b=1” by the priority setting unit 203 (Step S307), and avoids competition of the desired priority level with the terminal No. 1. The changed desired priority level “a=3” and “b=1” may be notified form the terminal No. 2 to the router 10 as a response to the priority change request.

In this way, data in each session of the terminal No. 1 is transmitted with the desired priority level “a=7” and “b=3”. On the other hand, data in each session of the terminal No. 2 is transmitted with the changed desired priority level “a=3” and “b=1”. That is, each frame transmitted from these terminals No. 1 and No. 2 is stored in the buffer unit 103, and a routing process is performed by the IP routing process unit 105. Further, each transmission bandwidth in accordance with a determined priority level is set by the priority control process of the priority control unit 106. Here, the determined priority level for the terminal No. 1 is the desired priority level as it is and the determined priority level for the terminal No. 2 is the changed desired priority level. And IP packets from the terminal No. 1 and IP packets from the terminal No. 2 are respectively transmitted to the WAN circuit by respective transmission speeds corresponding to the transmission bandwidth to be used. The routing process of the down stream is also performed similarly for IP packets received from the WAN circuit by the IP routing process unit 105, and those IP packets are transmitted to each destination terminal indicated by the destination address of IP packet.

Further, the router 10 can distinguish the priority level of an IP frame received from the terminal by referring to a value set in the ToS (Type of Service) field of the IP frame at beginning of communication with the terminal. Also, it is possible to specify the session to monitor as a priority control target from a source side port number and a sequence number/Ack number in a TCP frame which belongs to a higher layer of the IP frame. Even in case of a UDP (User Datagram Protocol) frame, it is possible to specify the session to monitor from the source side port number in the UDP frame.

When it is not desired for a terminal to be applied a priority change process, additional information which indicates the priority change is not acceptable is added to the management information transmitted from the terminal. In this case, the priority adjustment unit 107 of the router 10 does not transmit the priority change request to such a terminal which has added this additional information to the IP frame.

Further, the communication control unit 104, the priority control unit 106 and the priority adjustment unit 107 of the router 10 can be realized by executing software programs of the same function on the software program control processor such as CPU. Similarly, the controller 202 of the terminal and the priority setting unit 203 can also be realized by executing software programs of the same function on the software program control processor such as the CPU.

### 1.3) Effect

As mentioned above, according to the first exemplary embodiment, it is possible to realize efficient and stable data communication by dynamically adjusting the priority level between terminals even if there exist a plurality of sessions which require the priority control in the transmission bandwidth of the WAN circuit. According to this exemplary embodiment, it is possible to provide high-quality communication, which is meeting the needs of users, by performing optimum transmission control with a priority control function even in a communication environment in which various communication data streams are congesting.

### 2. Second Exemplary Embodiment

According to the second exemplary embodiment, each terminal notifies the router of the minimum required data transmission speed as well as a priority level of the terminal in advance. And when it becomes difficult to maintain the minimum data transmission speed for the session of terminal having high priority, the router transmits a change request of the minimum required data transmission speed successively to each terminal having low priority. By this arrangement, it becomes possible to realize efficient and stable data communication on the whole. Hereinafter, it is explained in detail.

### 2.1) Configuration

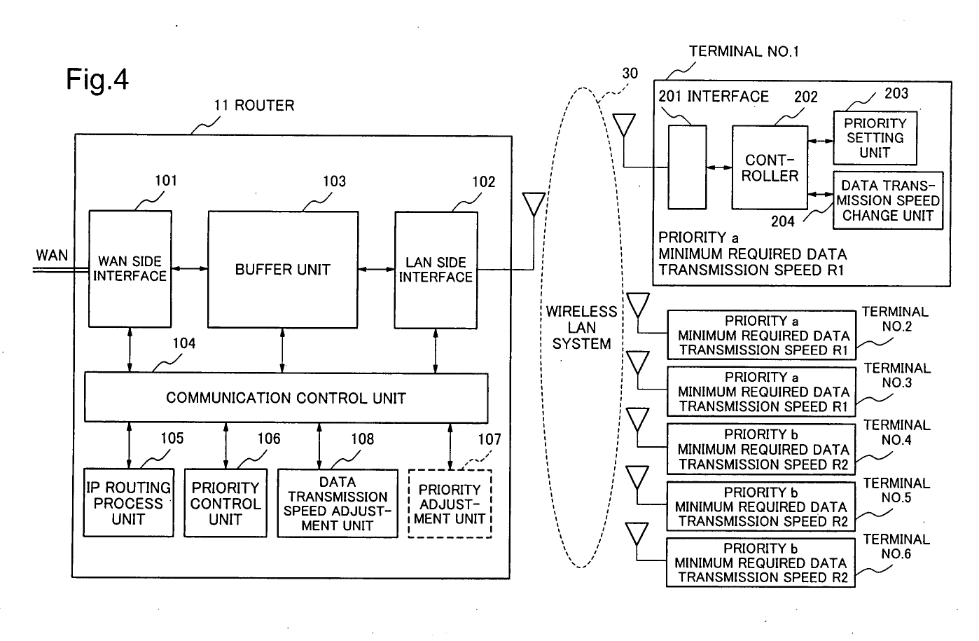

FIG. 4 is a block diagram showing an outline of system configuration of a communication system according to the second exemplary embodiment. However, the same reference number is given to a block having the same function as the system of the first exemplary embodiment shown in FIG. 1 and the related description is simplified.

In order to describe simply here, it is supposed that the wireless LAN system 30 includes a router 11 which is an access point and six terminals No. 1-No. 6. It is also supposed that a high priority value of “a” is set to the terminals No. 1-No. 3 as the priority level for these terminals, and a low priority value of “b” is set to the terminals No. 4-No. 6 as the priority level for these terminals. The priority value to be set is, for example, in the range “from 0 to 7”. Hereinafter, the priority value of “a” or “b” is also called as the priority level “a” or “b”. It is also supposed that the terminals No. 1-No. 3 with the high priority level “a” desire to perform communication with the data transmission speed of R1 as the minimum required data transmission speed, and the terminals No. 4-No. 6 with the low priority level “b” desire to perform communication with the data transmission speed of R2 (<R1) as the minimum required data transmission speed.

The router 11 has a data transmission speed adjustment unit 108, which adjusts the data transmission speed of communication for each terminal depending on the priority level, in addition to the WAN side interface 101, the LAN side interface 102, the buffer unit 103, the communication control unit 104, the IP routing process unit 105 and the priority control unit 106 which have already been described. Further, the priority adjustment unit 107 having the same function as the first exemplary embodiment may be provided (i.e., the priority adjustment unit 107 is shown with the dotted line in FIG. 4). Here, only functional constitution relating to the present invention is shown, and other configurations are omitted. The router 11 can transmits data from each of terminals through the WAN circuit having a predetermined transmission bandwidth respectively while dynamically adjusting the data transmission speed in accordance with the priority level of each of the terminals as will be described later.

The terminals No. 1-No. 6 have the same configuration basically, and the basic configuration other than having a data transmission speed change unit 204 is similar to the terminal No. 1 shown in FIG. 1. Specifically, the priority level “a” or “b” is set to the priority setting unit 203, and the controller 202 may have a function of notifying the minimum required data transmission speed and changing the data transmission speed with controlling the interface 201 and the data transmission speed change unit 204.

Further, the wireless LAN system 30, which includes the router 11 and the terminals No. 1-No. 6, is a wireless LAN system based on the standard of IEEE 802.11a or IEEE 802.11g, for example.

### 2.2) Operation

Next, operation of the router and the terminals according to this exemplary embodiment will be described; As mentioned above, the wired WAN circuit has 100 Mbps of transmission bandwidth, and the wireless LAN has 54 Mbps of all transmission bandwidth. 54 Mbps cannot be assigned to two sessions simultaneously. Accordingly, the router 11 according to this exemplary embodiment controls to maintain the minimum required data transmission speed for as many terminals as possible, and when it becomes difficult to maintain such control the router 11 transmits a data transmission speed change request to each terminal having the low priority level “b”. Hereinafter, it is explained in detail.

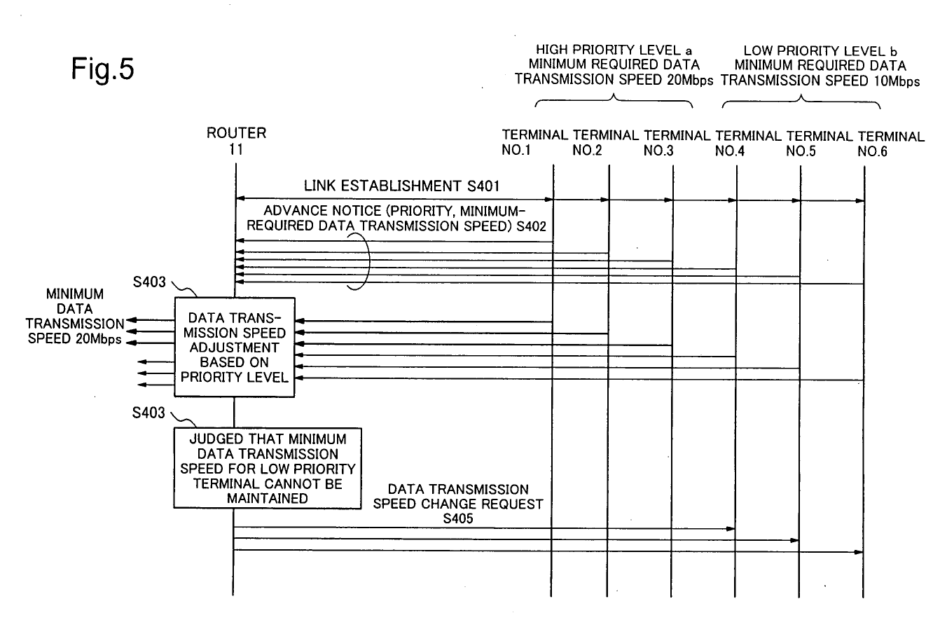

FIG. 5 is a sequence diagram showing an example of the communication control according to the second exemplary embodiment. First, the communication control unit 104 of the router 11 and each of the terminals No. 1-No. 6 establish a link in accordance with a predetermined protocol (Step S401).

After link establishment, each of the terminals No. 1-No. 6 communicates with the router 11 by using the HTTP protocol, for example. Each terminal transmits the management information which includes the number of sessions for performing simultaneous communication, the communication quality level (the priority level) of each session and the minimum communication speed requiring for each session (the minimum required data transmission speed) to the router 11 as an advance notice by using the HTTP protocol (Step S402). Here, it is desirable to use tag information for transmitting the advance notice. Accordingly, any protocol other than the HTTP protocol may also be used, as long as it is possible to add and transmit information as a tag. However, it is desirable to use a protocol higher than the layer 4 protocol because it is interposed by an application control.

As an example, in each of the terminals No. 1-No. 6, it is supposed that the number of sessions by TCP (Transmission Control Protocol) is 1, the terminals No. 1-No. 3 with the priority level “a=7” requiring the minimum required data transmission speed “R1=20 Mbps” and the terminal No. 4-No. 6 with the priority level “b=3” requiring the minimum required data transmission speed “R2=10 Mbps”.

The communication control unit 106 outputs the information included in the advance notice of each terminal to the data transmission speed adjustment unit 108, and data transmission speed adjustment depending on the priority level is performed by the data transmission speed adjustment unit 108 (Step S403). First, a session to be monitored by the communication control unit 106 under control of the data transmission speed adjustment unit 108 is determined when communication from the terminal has commenced. The data transmission speed adjustment unit 108 classifies each terminal into a high priority terminal and a low priority terminal in accordance with the priority level notified by the advance notice. That is, each of the terminals No. 1-No. 3 is classified into the high-priority terminal and each of the terminals No. 4-No. 6 is classified into the low priority terminal. The data transmission speed of each frame in the session of the monitoring target is monitored by the data transmission speed adjustment unit 108. The data transmission speed adjustment unit 108 performs a first adjustment of the data transmission speed among the terminals No. 1-No. 3 with the high priority level so that the terminals No. 1-No. 3 with the high priority level can maintain the data transmission speed over 20 Mbps. When it has become difficult to maintain the data transmission speed for the terminals No. 1-No. 3 with the high priority level by the first adjustment, the data transmission speed adjustment unit 108 performs a second adjustment of the data transmission speed. In the second adjustment, the data transmission speed of sessions relating to the terminals No. 4-No. 6 with the low priority level is decreased as much as possible while maintaining the minimum required data transmission speed of the respective sessions.

When it is still difficult to maintain the minimum required data transmission speed due to so many sessions being used (Step S404), the data transmission speed adjustment unit 108 performs a third adjustment of the data transmission speed. In the third adjustment, the data transmission speed change request is transmitted to each terminal with the low priority level from the router 11 (Step S405). Here, the data transmission speed adjustment unit 108 transmits the data transmission speed change request to the terminal in the order of lower priority. In an example shown in FIG. 5, because the terminals No. 4-No. 6 have the same low priority level “b”, the data transmission speed change request is transmitted in the order of the terminal number, i.e., No. 4, No. 5 and No. 6. The terminal which has received the data transmission speed change request changes minimum data transmission speed under control of the data transmission speed change unit 204 and the controller 202. In that case, it may ask the terminal user's instruction if necessary. It is the same when the data transmission speed cannot be maintained by an environmental condition. When the data transmission speed change request is accepted and the minimum data transmission speed is changed in the terminal, a revised minimum data transmission speed may be transmitted to the router 11 as a response to the data transmission speed change request.

Further, the communication control unit 104, the priority control unit 106 and the data transmission speed adjustment unit 108 of the router 11 can be realized by executing software programs of the same function on the program control processor such as CPU. Similarly, the controller 202, the priority setting unit 203 and the data transmission speed change unit 204 of the terminal can also be realized by executing software programs of the same function on the program control processor such as the CPU.

### 2.3) Effect

As mentioned above, according to the second exemplary embodiment, each terminal notifies the router of the minimum required data transmission speed as well as the priority level in advance, and the router transmits the data transmission speed change request to the terminal in the order of lower priority level when it has become difficult to maintain the minimum required data transmission speed for sessions of the terminal with the high priority level. By this arrangement, efficient and stable data communication can be realized on the whole.

### 3. Third Exemplary Embodiment

The first exemplary embodiment and the second exemplary embodiment mentioned above can be combined. That is, both of the priority adjustment unit 107 and the data transmission speed adjustment unit 108 are provided in the router, and each terminal notifies the router of the minimum required data transmission speed as well as the desired priority level in advance. In the router, the desired priority level is adjusted by the priority adjustment unit 107 as described in the first exemplary embodiment and the data transmission speed adjustment unit 108 performs the data transmission speed adjustment based on the desired priority level, which has been adjusted by the priority adjustment unit 107, as described in the second exemplary embodiment.

Thus, by arranging like this manner, the priority level among terminals is dynamically adjusted when there exist a plurality of sessions to be performed priority control to the transmission bandwidth of the WAN circuit. Further, when it has become difficult to maintain the minimum required data transmission speed for sessions of the terminal with higher priority level, the data transmission speed change request is transmitted to each terminal in the order of lower priority. Therefore, it is possible to realize efficient and stable data communication on the whole.

### 4. Fourth Exemplary Embodiment

According to the fourth exemplary embodiment, the priority control is performed for the various priority values being set to each of sessions by comparing with a predetermined reference priority value Pth, i.e., each priority value of session is compared with the predetermined reference priority value Pth. The priority value which is equal to or higher that the predetermined reference priority value Pth is determined as a high priority level, and the priority value which is lower than the predetermined reference priority value Pth is determined as a low priority level. Then, suitable priority control is performed depending on the priority level determined as a result of comparison with the predetermined reference priority value Pth. By this arrangement, efficient and stable data communication on the whole can be realized. Hereinafter, it is explained in detail.

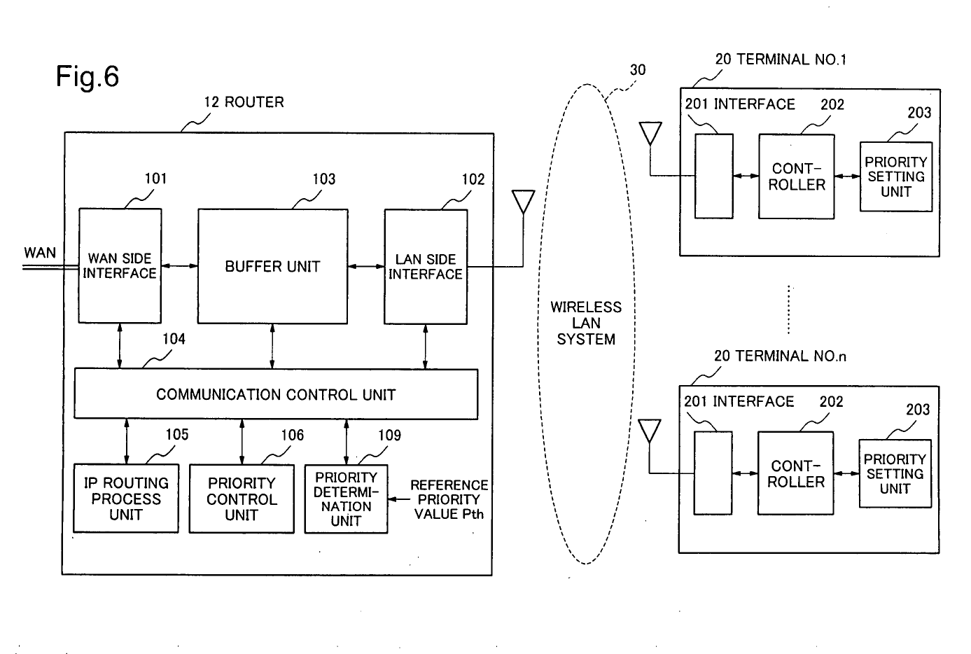

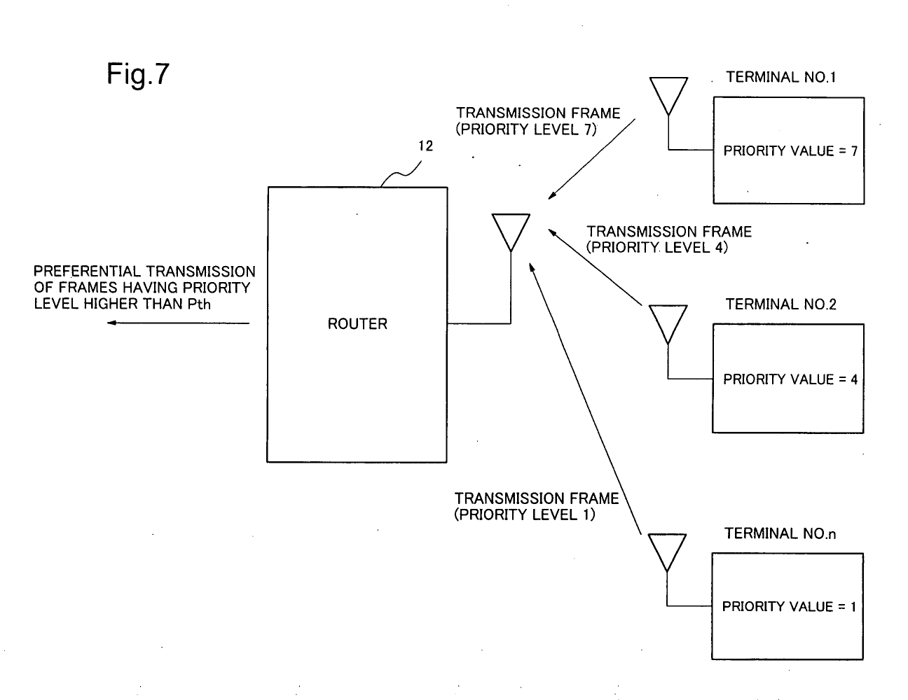

FIG. 6 is a block diagram showing an outline of system configuration of a communication system according to the fourth exemplary embodiment. FIG. 7 is a schematic block diagram showing a communication control example according to the fourth exemplary embodiment. However, the same reference number is given to a block having the same function as the system of the first exemplary embodiment shown in FIG. 1 and the related description is simplified.

In order to describe simply here, it is supposed that the wireless LAN system 30 includes a router 12 which is an access point and n terminals No. 1-No. n. It is supposed that each of the terminals No. 1-No. n has the priority value as the priority level of data transmission in the session. For example, as shown in FIG. 7, the priority value can be selected and set within the priority range “from 0 to 7” and each terminal has own priority value like the manner that the terminal No. 1 has the priority value=7, the terminal No. 2 has the priority value=4, (intermediates being omitted) and the terminal No. n has the priority value=1.

The router 12 includes a priority determination unit 109 in addition to the WAN side interface 101, the LAN side interface 102, the buffer unit 103, the communication control unit 104, the IP routing process unit 105 and the priority control unit 106 which have already been described. The priority determination unit 109 has the predetermined reference priority value Pth, and performs priority determination by comparing the priority value of each session with the reference priority value Pth. Further, only functional constitution relating to the present invention is shown here, and other configurations are omitted. The router 12 can perform an efficient data transmission process for a plurality of terminals through a predetermined transmission bandwidth of the WAN circuit respectively while dynamically adjusting the data transmission speed based on a determination result of the priority level of each of the terminals.

Further, the wireless LAN system 30, which includes the router 12 and the terminals No. 1-No. n, is a wireless LAN system based on the standard of IEEE 802.11a or IEEE 802.11g, for example.

Next, operation of the router and the terminals according to this exemplary embodiment will be described. As mentioned above, first, the communication control unit 104 of the router 12 and each of the terminals No. 1-No. n establish a link according to a predetermined protocol.

When communication from each of the terminals No. 1-No. n is commenced after link establishment, the communication control unit 104 of the router 12 inputs an IP frame received at first from each terminal to the priority determination unit 109. The priority determination unit 109 distinguishes a priority value of the first IP frame received from each terminal by referring to a value being set in the ToS field of the IP frame, and the priority determination unit 109 compares the distinguished priority value with the reference priority value Pth. The priority determination unit 109 returns the comparison result to the communication control unit 104. The comparison result indicates that the IP frame is a priority control target when the priority value is higher than the reference priority value Pth (4, for example), and also the comparison result indicates that the IP frame is not the priority control target when the priority value is lower than the reference priority value Pth. By this arrangement, the communication control unit 104 can distinguish each IP frame following the first IP frame whether it corresponds to the priority control target or not just by referring to a source address of each IP frame. The communication control unit 104 controls to transmit the IP frames determined as the priority control target preferentially by adjusting a volume of communication data (the data transmission bit rate) in accordance with the priority value under control of the priority control unit 106. And the communication control unit 104 controls to transmit the IP frames other than the priority control target by an appropriate priority control which is suitable for the low priority level, because an IP frame other than the priority control target is regarded as the IP frame having lower priority value than the predetermined reference priority value Pth.

Further, the communication control unit 104, the priority control unit 106 and the priority determination unit 109 of the router 12 can be realized by executing software programs of the same function on the program control processor such as CPU. Similarly, the controller 202 of the terminal and the priority setting unit 203 can also be realized by executing software programs of the same function on the program control processor such as the CPU.

By the exemplary embodiments according to the present invention described above, stabilization of communication traffics and high-quality communication for real time data of video and voice traffic can be expected. Further, the present invention can be applied not only to the wireless LAN but also to the wired LAN environment because the present invention is performed under control of the protocol higher than the IP layer. The present invention is applicable to the router of the wireless LAN and the wired LAN provided with multisession function which can handle a plurality of sessions for realizing efficient and stable communication.

While this invention has been particularly shown and described with reference to exemplary embodiments thereof, the invention is not limited to those specific embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A communication system comprising:
a plurality of terminals, each terminal having functions of handling a plurality of sessions, transmitting an advance notice including a desired priority level of each session at a time of starting communication, and changing the desired priority level when an priority change request is received; and
a router for communicating with the plurality of terminals, transmitting the priority change request to the terminals when it is determined that simultaneous communication of all sessions cannot be performed and the desired priority level competes among terminals if every desired priority level is permitted as it is without changing, and assigning a transmission bandwidth to each session according to a determined priority level corresponding to each of the plurality of sessions.

2. The system according to claim 1, wherein the router accepts the desired priority level indicated in the advance notice having received first when the desired priority level is competing among terminals, and transmits the priority change request to other terminals from which the competing desired priority level indicated in the advance notice having been received later to instruct to decrease the desired priority level.

3. The system according to claim 1,
wherein the terminal transmits the advance notice including a priority level and a minimum required data transmission speed of each session, and changes the minimum required data transmission speed when a data transmission speed change request is received, and
wherein the router classifies each of the plurality of terminals into a high priority terminal and a low priority terminal in accordance with the priority level, and transmits the data transmission speed change request to the low priority terminals to instruct to decrease the minimum required data transmission speed when the minimum required data transmission speed cannot be maintained.

4. A router having a function of handling a plurality of sessions comprising:
a communication control unit for communicating with a plurality of terminals, and receiving an advance notice from each terminal which indicates a desired priority level of each session of the terminal at a time of starting communication;
a priority adjustment unit for adjusting the desired priority level among terminals when it is determined that simultaneous communication of all sessions cannot be performed and the desired priority level competes among terminals if every desired priority level is permitted as it is without changing; and
a priority control unit for assigning a transmission bandwidth to each session according to a determined priority level corresponding to each of the plurality of sessions.

5. The router according to claim 4, wherein the priority adjustment unit accepts the desired priority level indicated in the advance notice having received first when the desired priority level is competing among terminals, and transmits a priority change request to other terminals from which the desired priority level indicated in the advance notice having been received later to instruct to decrease the desired priority level.

6. The router according to claim 5, wherein the advance notice including a priority level and a minimum required data transmission speed of each session of the terminal, the router further comprising:
a data transmission speed adjustment unit for adjusting the data transmission speed of communication for each session so as to maintain the minimum required data transmission speed in accordance with the priority level.

7. The router according to claim 6, wherein the data transmission speed adjustment unit classifies each terminal into a high priority terminal and a low priority terminal in accordance with the priority level, and maintains the data transmission speed for the high priority terminals to be over the minimum required data transmission speed while maintaining the data transmission speed for the low priority terminals to the minimum required data transmission speed.

8. The router according to claim 7, wherein the data transmission speed adjustment unit transmits a data transmission speed change request to the low priority terminals to instruct to decrease the minimum required data transmission speed when the minimum required data transmission speed cannot be maintained.

9. A router having a function of handling a plurality of sessions comprising:
a priority determination unit for distinguishing a priority value of an IP frame received at first from each terminal, and determining whether the IP frame is a priority control target or not by comparing the distinguished priority value with a predetermined reference priority value;
a communication control unit for communicating with a plurality of terminals, and determining whether each IP frame, which follows the IP frame received at first, being corresponding to-the priority control target or not in accordance with a notification from the priority determination unit; and
a priority control unit for adjusting a volume of communication data corresponding to the IP frames determined as the priority control target so as to be preferentially transmitted.

10. A communication control method for a router having a function of handling a plurality of sessions to communicate with a plurality of terminals, comprising:
receiving an advance notice from each of the plurality of terminals which indicates a desired priority level of each session of the terminal at a time of starting communication;
adjusting the desired priority level among terminals when it is determined that simultaneous communication of all sessions cannot be performed and the desired priority level competes among terminals if every desired priority level is permitted as it is without changing; and
assigning a transmission bandwidth to each session according to a determined priority level corresponding to each of the plurality of sessions.

11. The method according to claim 10, wherein the adjusting step includes,
accepting the desired priority level indicated in the advance notice having received first when the desired priority level is competing among terminals, and
transmitting a priority change request to other terminals from which the desired priority level indicated in the advance notice having been received later to instruct to decrease the desired priority level,
wherein the assigning step uses the accepted desired priority level and the decreased desired priority level as the determined priority level.

12. A communication control method for a router having a function of handling a plurality of sessions to communicate with a plurality of terminals, comprising:
receiving an advance notice from each terminal which indicates a priority level and a minimum required data transmission speed of each session of the terminal at a time of starting communication;
classifying each of the plurality of terminals into a high priority terminal and a low priority terminal in accordance with the priority level; and
maintains the data transmission speed for the high priority terminals to be over the minimum required data transmission speed while maintaining the data transmission speed for the low priority terminals to the minimum required data transmission speed.

13. The method according to claim 12, further comprising:
transmitting the data transmission speed change request to the low priority terminals to instruct to decrease the minimum required data transmission speed when the minimum required data transmission speed cannot be maintained.

14. The method according to claim 13, the advance notice further includes a desired priority level of each session of the terminal, further comprising:
accepting the desired priority level indicated in the advance notice having received first when it is determined that simultaneous communication of all sessions cannot be performed and the desired priority level competes among terminals if every desired priority level is permitted as it is without changing;
transmitting a priority change request to other terminals from which the desired priority level indicated in the advance notice having been received later to instruct to decrease the desired priority level; and
wherein the classifying step uses the accepted desired priority level and the decreased desired priority level for classifying each of the plurality of terminals into a high priority terminal and a low priority terminal.

15. A communication control method for a router having a function of handling a plurality of sessions to communicate with a plurality of terminals, comprising:
distinguishing a priority value of an IP frame received at first from each of the plurality of terminals;
comparing the distinguished priority value with a predetermined reference priority value for determining whether the IP frame is a priority control target or not;
determining each IP frame which follows the IP frame received at first whether it corresponds to the priority control target or not in accordance with a result of the comparing step; and
adjusting a volume of communication data corresponding to the IP frames determined as the priority control target so as to be preferentially transmitted.
